(19) United States
(12) Patent Application Publication
(10) Pub. No.: US 2012/0093025 A1
(43) Pub. Date: Apr. 19, 2012

(54) METHOD AND SYSTEM FOR DETECTING PACKET TYPE

(75) Inventors: Thomas E. PARE, JR., Mountain View, CA (US); Kiran ULN, Pleasanton, CA (US); Peter LOC, Cupertino, CA (US)

(73) Assignee: Ralink Technology (Singapore) Corporation PTE. LTD., Singapore (SG)

(21) Appl. No.: 13/087,151

(22) Filed: Apr. 14, 2011

Related U.S. Application Data
(63) Continuation-in-part of application No. 12/563,979, filed on Sep. 21, 2009.
Application No. 12/563,979 is a continuation-in-part of application No. 12/700,651, filed on Feb. 4, 2010.
Application No. 12/700,651 is a continuation-in-part of application No. 13/026,128, filed on Feb. 11, 2011.
(60) Provisional application No. 61/325,465, filed on Apr. 19, 2010.

(51) Int. Cl. H04L 12/26

(52) U.S. Cl. 370/253

(57) ABSTRACT

It is therefore an object of the present invention to provide a method for detecting different packet type. The method comprises, determining whether the rate of a received packet corresponds to a predetermined rate, derotating the bits of a symbol in the received packet, obtaining an energy different of the symbol at different axes, and determining the type of the received packet according to the energy difference.

### CROSS REFERENCE TO RELATED APPLICATIONS

The present application claims the benefit of U.S. Provisional Application No. 61/325,465, filed on Apr. 19, 2010, entitled “METHOD AND SYSTEM FOR DETECTING PACKET TYPE,” and is a continuation-in-part of U.S. patent application Ser. No. 12/563,979, filed on Sep. 21, 2009, entitled “METHOD AND SYSTEM TO DETECT PACKETS OF DIFFERENT FORMATS IN A RECEIVER,” and U.S. patent application Ser. No. 12/700,651, filed on Feb. 4, 2010, entitled “METHOD AND SYSTEM TO DETECT PACKETS OF DIFFERENT FORMATS IN A RECEIVER,” and U.S. patent application Ser. No. 13/026,128, filed on Feb. 11, 2011, entitled “METHOD AND SYSTEM TO DETECT PACKETS OF DIFFERENT FORMATS,” all of which are incorporated herein by reference in their entirety.

### FIELD OF THE INVENTION

The present invention relates generally to wireless data communication systems and more particularly to the detection of different types of packets.

### BACKGROUND OF THE INVENTION

In a wireless communication system such as a WiFi system, information is transmitted and received in orthogonal frequency-division multiplexing (OFDM) packets. A receiver in such a system needs to detect a packet and its format first, and then the receiver configures its hardware and software to receive and decode the data portion of the packet.

Each OFDM packet includes a plurality of pre-amble fields to assist the receiver in detecting, synchronizing, and conditioning the packet. The pre-amble fields are followed by an encoded signal field that carries information about data rate, packet length, modulation and encoding type. The signal field is decoded and then used to configure the receiver to receive and decode the data portion of the packet. In the high throughput (HT) WiFi standard IEEE draft document (802.11n), mixed mode and green field OFDM frame formats are allowed to co-exist with a low throughput legacy frame format. In this standard the mixed mode frame format allows a legacy device to handle an HT packet properly and the green field frame format allows for less overhead and therefore higher throughput in an HT only system.

Accordingly, what is desired is a system and method that allows a receiver to receive and decode data packets in an efficient fashion when the receiver can receive packets in different types of formats. The system and method should be easily implemented, cost effective and adaptable to existing communications systems. The present invention addresses such a need.

### SUMMARY OF THE INVENTION

A method and system for detecting different packet types is disclosed. The method and system comprises, determining whether the rate of a received packet corresponds to a predetermined rate, and derotating the bits of a symbol in the received packet. The method and system further includes obtaining an energy difference of the symbol at different axes, and determining the type of the received packet based on the energy difference.

Other aspects and advantages of the present invention will become apparent from the following detailed description, taken in conjunction with the accompanying drawings, illustrating by way of example the principles of the invention.

### BRIEF DESCRIPTION OF DRAWINGS

The accompanying drawings illustrate an embodiment of the present invention and, together with the description, serve to explain the principle of the invention. One skilled in the art will recognize that the particular embodiments illustrated in the drawings are merely exemplary, and are not intended to limit the scope of the present invention.

FIG. 1 shows the structures of conventional packets.

FIG. 2 illustrates encoding schemes of the conventional packets.

FIG. 3 illustrates a structure of a VHT packet.

FIG. 4 shows the constellation diagrams of the odd subcarriers and the even subcarriers.

FIG. 5 is an approach to distinguish the 11n HT-SIG field.

FIG. 6 is a flow chart of a conventional method to determine whether an incoming packet is a 11ag packet or a 11n packet.

FIG. 7 illustrates a flow chart of a method to determine whether an incoming packet is a 11ag packet, an 11n packet, or a VHT packet (11ac) according to an embodiment of the present invention.

### DETAILED DESCRIPTION OF PREFERRED EMBODIMENTS

The present invention relates generally to wireless data communication systems and more particularly to the detection of different types of packets. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

A system and method in accordance with the present invention allows for a receiver to effectively detect and decode the format of a plurality of packets transmitted in a wireless network. Specifically, the system allows for a receiver which can receive packets in different formats to detect whether the IEE802.11n packets are in a very high throughput (VHT) format or a legacy OFDM format. In so doing, a receiver can operate efficiently when receiving and decoding packets.

Although an embodiment will be described based upon a WiFi system in which OFDM packets are utilized, one of ordinary skill in the art recognizes a system and method in accordance with an embodiment can be utilized in a variety of embodiments and that use would be within the spirit and scope of the present invention. For example, the receiver could receive Complementary Code Keying (CCK) packets, Ethernet packets and the like and their use would be within the spirit and scope of the present invention. For example, the types of high throughput formats may differ from mixed mode format and the green format disclosed herein but those formats would still be applicable in a system and method in accordance with the present invention. Accordingly, although the system and method in accordance with the present invention will be discussed in the context of a particular embodiment, one of ordinary skill in the art recognizes that it can be utilized in a variety of environments and is not limited to the embodiments described herein.

A system that utilizes a detection procedure in accordance with the present invention can take the form of an entirely hardware implementation, an entirely software implementation, or an implementation containing both hardware and software elements. In one implementation, this detection procedure is implemented in software, which includes, but is not limited to, application software, firmware, resident software, microcode, etc.

Furthermore, the detection procedure can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk—read/write (CD-RAN). To describe the features of the present invention in more detail, refer now to the following description in conjunction with the accompanying figures.

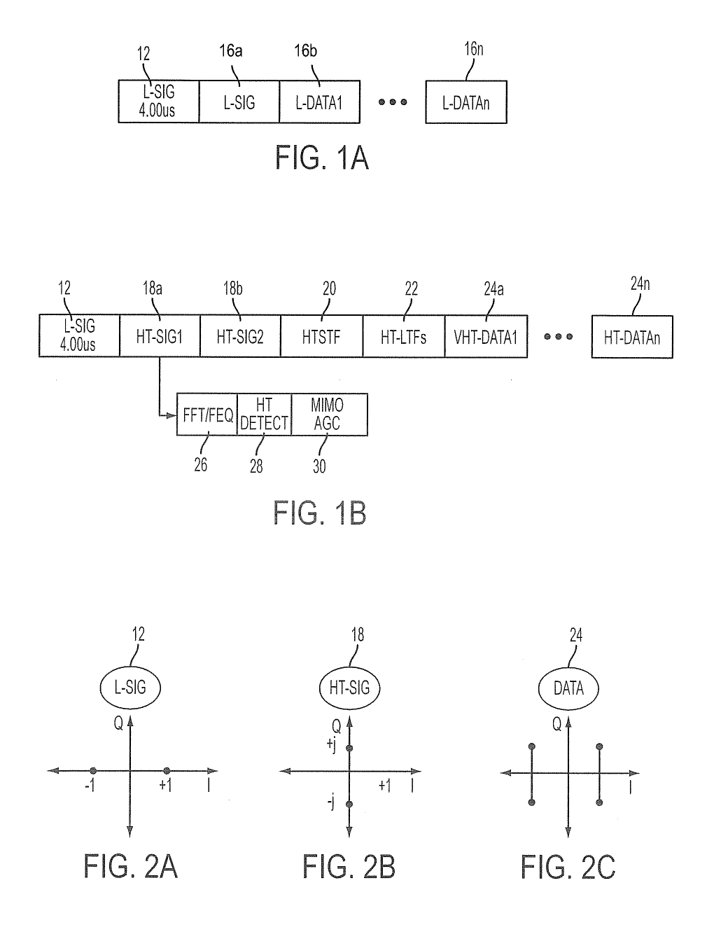

FIG. 1 shows the structures of conventional packets. The portion (a) illustrates a packet structure 10 used in a wireless device complying with IEEE 802.11a standard (legacy mode), while the portion (b) illustrates a high throughput (HT) packet structure 10 used in a wireless device complying with the IEE 802.11n standard. The portion (a) shows the portion of the 11a legacy packet following the short and long training fields (SFT and LTF), which are primarily for packet detection, auto gain control (AGC) and channel training. The signal field, as defined in the specification IEEE 802.11a standard, contains the signal information pertaining to the data portion of the packet, such as data modulation, number of symbols, coding rate, and parity bit protection. A receiver that receives the packet uses this information, contained in the L-SIG symbol 12 shown in the portion (a), to set-up the subsequent decoding processing the data symbols. The IEEE 802.11a standard defines a packet data rate of up to 54 Mb/s.

With the release of the draft IEEE 802.11ac standard, a new preamble of the packet is defined for a typical packet data rate—as high as 600 Mb/s. The new preamble requires an extensive set of signal parameters that necessitates the expansion of the signal field into two symbols, such as the HT-SIG1 18a and HT-SIG2 18b shown in the portion (b), immediately following the L-SIG 12 field. To ensure co-existence with the 11a devices, the HT-SIG fields 18a and 18b are modulated with a 90-degree rotation. Compared with a conventional BPSK symbol with real components, the HT-SIG fields 18a and 18b are signaled on the imaginary (Q) axis, as shown in FIG. 2. This makes the detection of the packet easy, after processing the symbol through signal processing modules, such as the FFT and FEQ modules 26 shown in portion (b). As depicted in portion (b), the approximate time duration that an 11n device will require to detect an HT packet by HT detector 23 is approximately 1 symbol time (or about 4 microseconds). That is, the signal processing time, such as the FFT/FEQ/HT-DETECT 28 process shown in the portion (b), begins from the last HT-SIG1 18a sample transmitted by the transmitter, and will be completed before the HT-STF 20 is transmitted over the air, or received by a receiver. Thus, upon detection, an 11n receiver has enough time to properly process the HT-STF field 20. During this field, the analog and digital MIMO-AGC 30 functions are performed, using the HT-STF signal that is specially designed for this purpose; for example, the 802.11a/n STF field 20 has a low peak-to-average power ratio, which ensures that the signal can tolerate large power increases, without saturating the receiver analog-to-digital converters.

MIMO-AGC 30 is important for performance prior to the reception of the HT-LTF 2 (long training fields). Significant gain changes can occur at the start of the HT-STF 20 for several reasons. For example, CSD changes (from 200 up to 600 microseconds on the transmitted spatial streams) can drastically change the effective wireless channel. Transmit beamforming can also result in 6 to 10 dB of received signal gain increase, and transmit antenna diversity schemes starting at the HT-STF 20 (according to the 11n standard) and spatial expansion (also an 802.11n feature, whereby the transmitter activates additional transmitters) can further modify the channel. These abrupt changes need to be compensated by the MIMO-AGC 30 to prevent effects such as analog-to-digital conversion (ADC) saturation (clipping).

Moreover, with a very high throughput (VHT) standard, which offers even higher data rates, a preamble field must be designed to allow a VHT device to coexist with both 11a and 11n devices. The signal field will preferably be as efficient as the HT-SIG field 18a and 18b, immediately following the L-SIG field 12 as shown in FIG. 1, and allow the VHT preamble to be uniquely distinguishable from the previous two preambles, and finally, and equally important, the VHT detection is required to be timely, so that the VHT detection occurs before the start of the HT-STF symbol 20 so that a full symbol time (i.e., four microseconds) is available for MIMO-AGC 30.

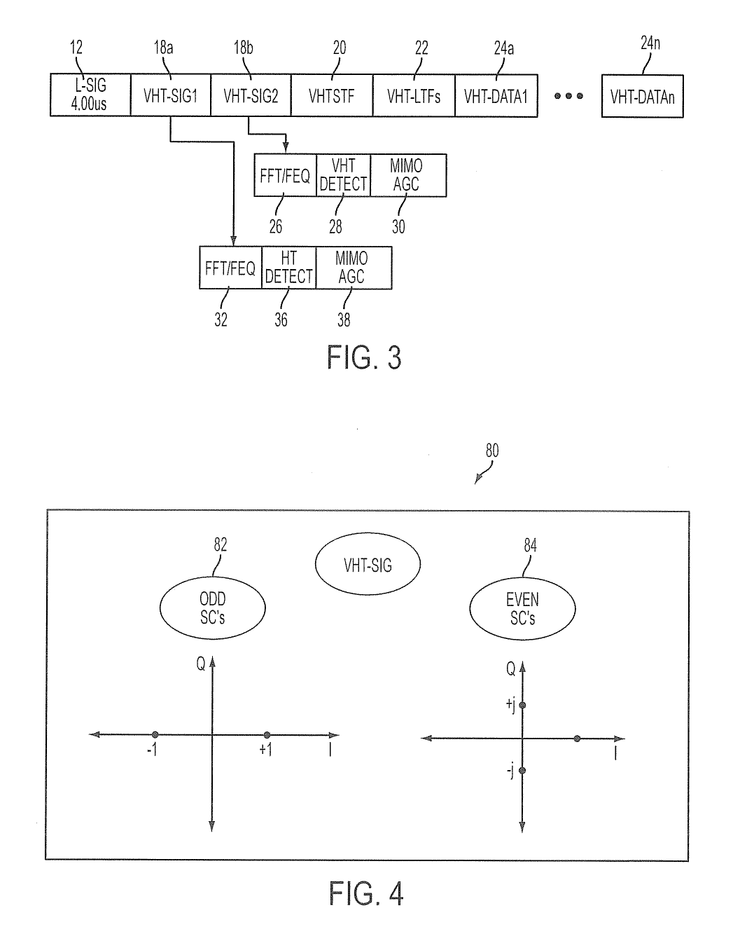

An approach known to solve the current problem is shown in FIG. 3. In this embodiment 90-degree rotation is used on the HT-SIG2 field 18b for VHT detection. HT and VHT detection is done sequentially, with the VHT 28 and 30 detection logic searching for the 90-degree shift on either the first signal field 18a (indicating the 11n HTpacket) or the second signal field 18b (indicating the VHT packet is present). The limitation with this implementation is that when detection for the VHT packet is delayed to the second VHT signal field VHT-SIG2 18b, the resulting MIMO AGC processing 30 must occur during the VHT-LTFs 22, which is problematic since any gain adjustments must occur prior to the these training fields.

One solution, as presented in application Ser. No. 12/563,979, is achieved, by generalizing the 90-degree rotation so that the new VHT-SIG can be easily recognized. That is, a new subcarrier rotation allows the VHTSIG to be distinguished from both an HT-SIG field and a legacy DATA field simultaneously. One embodiment of the design utilizes 90-degree BPSK symbols on alternating subcarriers, odd and even, as shown in FIG. 4. FIG. 4 shows the constellation diagrams of the odd subcarriers 82 and the even subcarriers 84. Using a detection scheme, this preamble will accomplish the VHT coexistence requirement, and allow the HT and VHT detection to occur on the xHT-SIG1 field, allowing adequate time for MIMO-AGC processing 38 to occur during the STF fields 20.

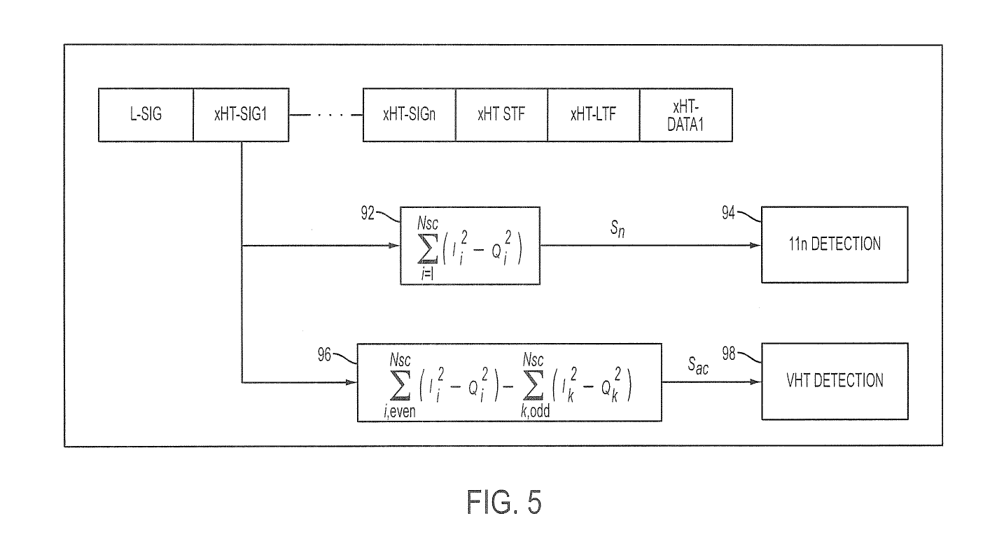

An approach to distinguishing the 11n HT-SIG field is shown in FIG. 5. Here the 11n HT-SIG field is distinguished by summing the difference in power between the real (I component) and imaginary (Q component) BPSK symbols, across all of the rotated subcarriers. This is shown as element 92 as is written as (Equation 1.1):

$$11 n \text{:} {\sum }_{i = 1}^{Nsc} ( {I}_{i}^{2} - {Q}_{i}^{2} )$$

In particular, if the packet is an 11n packet with the 90-degree shifted BPSK OFDM symbol, all the energy will line up on the imaginary axis, making the Q components large. The output will be a large negative number received by 11n detection mechanism 94. It will be distinguishable from an 11a packet, because the 11a packet will have a data symbol in that corresponding time slot. In general, the data symbol in QAM, and contains equal energy on both I and Q components, so that if the packet is 11a, the output of the 11n detector will read zero. Thus, by comparing the summed output to a preset negative threshold, the 11n and 11a can be uniquely identified.

| | Data | | | |
|---|---|---|---|---|
| Metric | Symbol | 11a L-SIG | 11n HT-SIG | VHT-SIG |
| 11n | 0 | S | −S | 0 |
| VHT | 0 | 0 | 0 | −S |

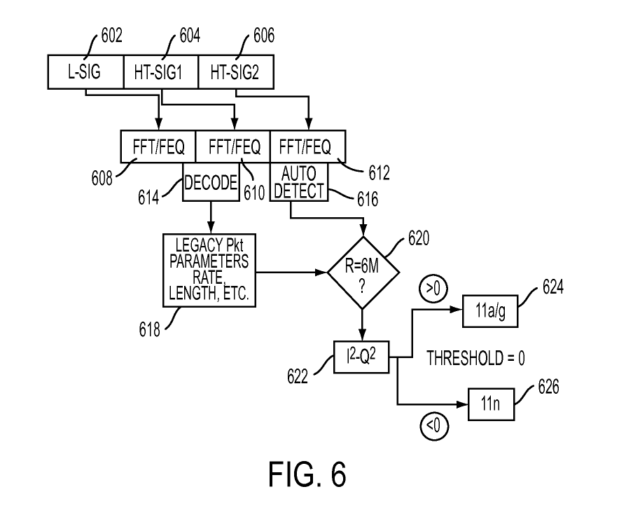

FIG. 6 is a flowchart of a conventional method for distinguishing packets that comply with IEEE 802.11a or IEEE 802.11g standard (11ag packets) and packets that comply with IEEE 802.11n standard (11n packets). As is seen, the signals from L-Sig field 602, HT-Sig field 604 and HT-Sig field 606 are provided to FFT/FEQs 608-612. A decoder 614 coupled to FFT/FEQ 610 provided to legacy parameter block, via step 618. When a packet is received, auto-detection, via step 616, is performed and the rate is set as 6 Mbits/s. If the rate is 6 Mbits, the difference between the square of the in-phase part and the square of the quadrature part of a certain symbol or certain symbols of the input packet is calculated, via step 620. If the result is positive, or larger than zero, the input packet is determined as a 11ag packet, via step 624. On the other hand, if the result is negative, or smaller than zero, the input packet is determined as a 11n packet, via step 626. Since the symbol or symbols are transmitted using binary phase shift keying (BPSK), this distinction can be made. For transmitting a 11ag packet, the energy of these symbols are on the in-phase axis with the quadrature part close to zero. For a 11n packet, the energy of these symbols are on the quadrature axis, which is 90 degrees from the in-phase axis, and the in-phase part close to zero.

However, a newly proposed wireless area network (WLAN) standard, IEEE.802.11ac or 11ac, is now being developed. For a packet that complies with the proposed 11ac standard, or a 11ac packet, an alternating subcarrier has a 90 degree shift, which may mean that the degree of a bit and the degree of the previous bit or then next bit in the symbol or symbols has a 90 degree difference. In other words, there's an alternate 0/90 degree BPSK symbols on odd-even subcarriers. In this case, the above-identified method cannot be used to determine the type of received packet because the result of the energy difference of the in-phase axis and the quadrature axis are close to zero. Therefore it is very possible for an 11n receiver to make a false detection. Thus, there is a need for a method to detect a different a packet format.

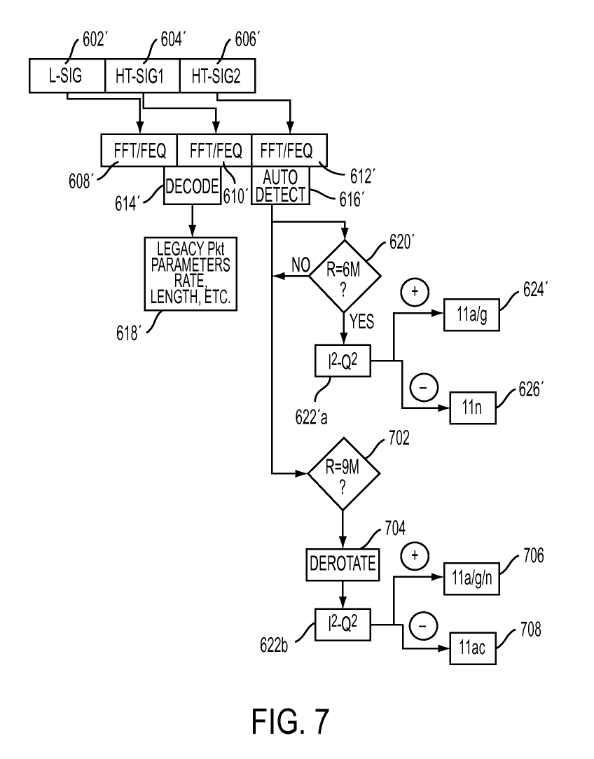

FIG. 7 illustrates a flow chart of a method for detecting the packet type according to an embodiment of the present invention. As can be seen, this method has elements very similar to the method shown in FIG. 6 to detect 11n and 11ag packet. Accordingly, when a packet is received, certain symbol or symbols are processed first to determine the packet type. In this embodiment, the long signal field (L-SIG) 602′, the high throughput signal field 1 (HT-SIG1) 604′ and the high throughput signal field 2 (HT-SIG2) 606′ are processed first. In one embodiment, a rate of 9 Mbits/s is recorded in the symbol or symbols, such that the receiver may use the detection method according to the present invention. If it is determined that the packet is a 9 Mbits packet, via step 702, as mentioned earlier, there's an alternate 0/90 degree BPSK symbols on odd/even subcarriers. Therefore, the degrees of the subcarriers can be 0, 90, 0, 90, . . . or 45, −45, 45, −45, . . . . Since there are different types of rotations, a de-rotation of the subcarriers, via step 704, such as a −45 degree rotation, is performed. The difference of the energies on the in-phase part and the quadrature part of the even subcarriers and the odd subcarriers are then calculated, via step 722b, respectively. Afterwards, the packet type is determined by the difference between the energy differences of the in-phase part and the quadrature part of the even and off subcarriers to determine if the packet is a 11a/g packet or an 11ac packet.

In an embodiment, equation shown below may be used to calculate the energy difference used to determine the packet type.

$$11 a c \text{:} {{\sum }_{i , even}}^{Nsc} ( {I}_{i}^{2} - {Q}_{i}^{2} ) - {\sum }_{k , odd}^{Nsc} ( {I}_{k}^{2} - {Q}_{k}^{2} )$$

Accordingly, a method and system in accordance with the present invention presents a new packet structure and an improved method for detecting the packet.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method of communicating packets of different types in a transmitter, the method comprising:
determining whether a rate of received packet corresponds to a predetermined rate;
derotating bits of a symbol in the received packet if the packet is at the predetermined rate;
obtaining an energy difference of the symbol at different axes; and
determining the type of received packet based on the energy difference.

2. The method of claim 1, wherein the difference of energies between the in phase part and the quadrature part of even and off subcarriers are calculated.

3. The method of claim 1, wherein the predetermined rate is 9 Mbits/sec.

4. The method of claim 1, wherein the type of received packets comprise any of a 11a/g packet, 11n packet and a 11ac packet.

5. A system of communicating packets of different types in a receiver, the method comprising:
means for determining whether a rate of received packet corresponds to a predetermined rate;
means for derotating bits of a symbol in the received packet if the packet is at the predetermined rate;
means for obtaining an energy difference of the symbol at different axes; and
means for determining the type of received packet based on the energy difference.

6. The system of claim 5, wherein the difference of energies between the in phase part and the quadrature part of even and off subcarriers are calculated.

7. The system of claim 5, wherein the predetermined rate is 9 Mbits/sec.

8. The system of claim 5, wherein the type of received packets comprise any of a 11a/g packet, 11n packet and a 11ac packet.
